(19) United States
(12) Patent Application Publication
(10) Pub. No.: US 2014/0292090 A1
(43) Pub. Date: Oct. 2, 2014

(54) IMPLEMENTING WIRELESS POWER TRANSFER WITH 60 GHZ MMWAVE COMMUNICATION

(71) Applicants: Carlos Cordeiro, Portland, OR (US); Guoqing Li, Portland, OR (US); Ali S. Sadri, San Diego, CA (US); Bahareh Sadeghi, Portland, OR (US)

(72) Inventors: Carlos Cordeiro, Portland, OR (US); Guoqing Li, Portland, OR (US); Ali S. Sadri, San Diego, CA (US); Bahareh Sadeghi, Portland, OR (US)

(21) Appl. No.: 13/993,208

(22) PCT Filed: Dec. 9, 2011
(86) PCT No.: PCT/US11/64160

§ 371 Date: Apr. 14, 2014

(51) Int. Cl. H04B 5/00

(52) U.S. Cl. CPC H04B 5/0037
USPC 307/104

(57) ABSTRACT

A system and method are provided to form multiple separate beamformed wireless communication links between a 60 GHz mmWave transmitter and a cooperating 60 GHz mmWave receiver, to transfer not only wireless data communication between the cooperating devices, but also to transmit usable wireless power between the cooperating devices. These systems and methods employ a technology for establishing multiple beamformed wireless communication links between cooperating 60 GHz mmWave communication devices to transfer wireless data communication between the cooperating devices, and separately to transmit usable wireless power between the cooperating devices over separate wireless directional beamformed links between the devices providing efficient and effective wireless power transmission between the devices based on the directionality of the beamformed links. Because 60 GHz mmWave transmissions are highly directional, with beamwidths on the order of 10-20 degrees, power loss based on wasted energy when compared to existing omnidirectional wireless power transmission systems is significantly reduced.

### BACKGROUND

1. Field of the Disclosed Embodiments

This disclosure relates to systems and methods for implementing wireless power transfer using 60 GHz millimeter wave (mmWave) communication.

2. Related Art

Wireless communicating technologies of all types and in various applications have experienced phenomenal growth in the past decade. Hand-held wireless communication devices of all types including, for example, smart phones, PDAs, tablets and other like devices are now commonplace. These devices provide convenience and increase productivity for their users based, among other things, on their portability stemming from the lack of any need for wired connections of any kind

Wireless system developers continue to expand areas in which the capabilities of wireless communication can be exploited. In this regard, wireless power or wireless energy transfer has become an increasingly important area of concentration for developmental efforts.

The terms wireless power and wireless energy transfer refer generally to a class of techniques for the transmission of electrical energy from a power source to power sink, which may include a power storage device or an electrical load, with at least one non-wired connection, i.e., no circuit or physical conductor connection, between the power source and the power sink. Wireless power transfer, like other wireless communicating techniques, exploits the convenience provided in being able to establish an electrical/electronic connection between cooperating devices in applications where physical interconnections are impractical, or at a minimum, overly restrictive.

Wireless power transfer is based on the well-known physical phenomenon of magnetic induction. As such, wireless power transfer requires two coils: a transmitter coil and a receiver coil. An alternating current in the transmitter coil generates a magnetic field that induces a voltage in the receiver coil. This voltage is transferred to the power sink to, for example, power the electrical load or charge the power source, such as a battery.

FIG. 1 illustrates an exemplary overview of an existing wireless power transmission system. As shown in FIG. 1, a power transmission device 100 communicates with a power reception device 150. The power transmission device 100 and the power reception device 150 are often positioned between a communication system 120 and a power sink 170. The power sink 170 may be a power load device, such as, for example, a device that is powered by the power received by the power reception device 150, or a power storage device, such as, for example, a battery that is recharged by the power received by the power reception device 150.

At the power transmission device 100, a power converter device 102 generates a power signal 130 that is transmitted via its own transmitter to a receiver in a power pickup device 152 in the power reception device 150. The power pickup device 152, in turn, communicates received energy from the power signal 130 as a power input to the power sink 170, e.g. to power a local device or to charge a battery.

Each of the power transmission device 100 and the power reception device 150 includes a control/signal device 106,156 and a wireless communication device 104,154. The control/signal device 156 in the power reception device 150 is in direct communication with the power sink 170 to, for example, assess a status of the power sink 170, such as a power requirement to be delivered to a load or a charge status of a power storage device that constitute the power sink 170. The control/signal device 156, in turn, generates a control signal 140 that the power reception device 150 transmits via its wireless communication device 154 to the wireless communication device 104 in the power transmission device 100. This control signal 140 may be generated by the control/signal device 156 in the power reception device 150 when, for example, it may be necessary to indicate that more energy is or is not required by the power sink 170.

In instances where a determination is made by the control/signal device 156 in the power reception device 150 that no more energy is required by the power sink 170, the control signal 140 may indicate, via the above communication path between wireless communication devices 154,104, to the control/signal device 106 in the power transmission device 100 that it is appropriate for the control/signal device 106 to direct the power converter device 102 to stop transmitting the power signal 130 to the power pickup device 152. The control/signal devices 106,156 in each of the power transmission device 100 and the power reception device 150 may control the respective devices to turn off the respective power converter device 102 and the power pickup device 152 used for power signal transmission/reception.

Energy transmission issues for wireless power transmission differ from energy transmission issues experienced in other wireless communications. In typical wireless data communications, the portion of the transmitted energy that is received by a receiving device need only exceed noise and interference thresholds to be effectively received, and used, by the receiving device. In wireless power transmission, however, in order for the transmitted energy to be effective, it must be much more efficient, i.e., a comparatively large portion of the transmitted energy generated at the power source must be received by the receiving device.

Based on the above, many existing wireless power transmission systems suffer from a number of drawbacks. First, conventional wireless power transmission signals are often transmitted omnidirectionally. Therefore, considerable amounts of the transmitted energy are lost in transmission between the power source and a receiving device, and therefore, are wasted. This is based on the omnidirectional transmissions being broadcast in a manner that the receiving device may only be capable of capturing a small fraction of the transmitted energy. Second, in conventional wireless power transmission systems, cost and complexity are relatively high due to the need to have two separate transmission/reception interfaces: one for wireless power and one for control.

### SUMMARY OF THE DISCLOSED EMBODIMENTS

A first generation of mmWave, such as 60 GHz, wireless communication systems is in the process of being standardized as, for example, the proposed IEEE 802.11ad/WiGig standard. A broad spectrum of products that support mobile 60 GHz mmWave wireless communication are being developed and manufactured. Currently-planned 60 GHz mmWave capable devices can be equipped with one or more antennas consisting of a plurality of elements each, e.g., up to 64 elements. These “existing” mmWave wireless communication devices, and the systems within which they operate, currently are intended to select a single transmit and receive path between two cooperating devices.

In 60 GHz mmWave systems, communications are predominantly directional and transmitted across specifically directional beamformed wireless communication links between cooperating communicating devices. This characteristic is primarily based on the high level of atmospheric attenuation experienced by these systems and the need to form directional beams to provide any reasonable communication link between the cooperating communicating devices. A directional beamforming protocol, such as that defined as part of the proposed IEEE 802.11ad/WiGig standard, is used to define the single communication path between a cooperating pair of communicating device antennas at, for example, a transmitting and a receiving side. Beamforming techniques in 60 GHz mmWave wireless communicating systems are complex and require significant computing overhead to accomplish as they use the presence of multiple antenna elements in respective antennas at the transmit and receive sides and manipulation of those multiple antenna elements to shape the directional beamformed wireless communication link at each of the transmit and receive sides.

Those of skill in the art recognize that the term “beamforming” refers to a class of well-known signal processing techniques used in certain antenna arrays for manipulating directional signal transmission or reception. One technique is to combine elements in the particular antenna array in a way that signals at particular angles experience constructive interference, while other signals experience destructive interference. Beamforming, therefore, takes advantage of interference to change the directionality of the transmitted signal. Beamforming can be used at both the transmit and receive sides in order to achieve spatial selectivity.

FIG. 2 illustrates an exemplary overview of a currently-planned first generation 60 GHz mmWave wireless communication system 200 including exemplary beamforming according to proposed first generation 60 GHz mmWave wireless communication standards. First generation 60 GHz mmWave communication standards and products are intended to only support a single directional beamformed wireless communication link 270 between a cooperating pair of a first wireless communication device 220 and a second wireless communication device 240. Although the first and second wireless communication devices may act as either transmitters or receivers, for clarity in the following discussion reference will be made to the depicted first wireless communication device 220 as constituting a transmitting side and to the depicted second wireless communication device 240 as constituting a receiving side. This characterization is not intended the limiting in any manner. Individual transmitting antenna elements 230A-X then and individual receiving antenna elements 250A-X are employed to produce the single directional beamformed data communication link 270 respectively at the transmitting side and the receiving side of the exemplary 60 GHz mmWave communication system for the same single signal S1 that is transmitted across the single directional beamformed wireless communication link 270. In addition, proposed first generation 60 GHz mmWave wireless communication standards use a single antenna for communication.

FIG. 2, in its illustration of how currently-planned 60 GHz mmWave wireless communication systems are intended to operate, depicts that these systems, as planned, are only capable of transmitting communication application data, e.g., video data, file transfer data, web browsing data, and the like over a single directional beamformed wireless communication link 270 between cooperating devices.

Given the fact that 60 GHz mmWave transmitting node devices are anticipated to be equipped with multiple antennas including individually and collectively comparatively large numbers of antenna elements, i.e. up to 64 antenna elements per antenna, in the proposed IEEE 802.11ad/WiGig standard, it should be possible to allocate multiple combinations of multiple antenna elements to establishing multiple separate beamformed wireless communication links dedicated to multiple, and potentially diverse, purposes.

U.S. patent application Ser. No. ______ (Attorney Docket No. 064-0050), assigned to the same Assignee as this application, the disclosure of which is hereby incorporated by reference herein in its entirety, proposes a scheme whereby multiple separate beamformed wireless communication links may be established between a pair of cooperating mmWave wireless communication devices. The 0050 disclosure discusses how these multiple separate beamformed wireless communication links may be usable to implement a multiple-input multiple-output (MIMO) concept in a next generation mmWave communication system.

It would be advantageous to find some manner by which to exploit a capability to form multiple separate beamformed wireless communication links between a 60 GHz mmWave transmitter and a cooperating 60 GHz mmWave receiver, to transfer not only wireless data communication between the cooperating devices, but also to transmit usable wireless power between the cooperating devices.

In various exemplary embodiments, the systems and methods according to this disclosure propose to advantageously employ a technology for establishing multiple beamformed wireless communication links between cooperating 60 GHz mmWave communication devices, such as, for example a 60 GHz transmitter and a cooperating 60 GHz mmWave receiver, to transfer wireless data communication between the cooperating devices, and separately to transmit usable wireless power between the cooperating devices.

In various exemplary embodiments, the systems and methods according to this disclosure propose to employ 60 GHz mmWave directional beamformed signals for efficient and effective wireless power transmission between cooperating devices operating in the 60 GHz mm mmWave region of the radio-frequency (RF) spectrum.

In various exemplary embodiments, the systems and methods according to this disclosure seek to take advantage of the inherent directional transmission characteristics of 60 GHz mmWave beamformed signals that make these signals uniquely suited to provide an improved technology for wireless power transmission. Because 60 GHz mmWave transmissions are highly directional, with beamwidths on the order of 5-30 degrees, power loss based on wasted energy when compared to existing omnidirectional wireless power transmission systems may be significantly minimized.

In various exemplary embodiments, the systems and methods according to this disclosure seek to take advantage of current efforts at producing products including 60 GHz mmWave technologies, based on the proposed IEEE 802.11ad/WiGig standard, to enable those devices to transmits not only data via wireless communication, but power as well.

In various exemplary embodiments, the systems and methods according to this disclosure may advantageously employ the characteristics of planned 60 GHz mmWave antenna arrays, including multiple antenna elements in each antenna array, which differ from current omnidirectional systems for wireless power transmission, to implement an antenna element allocation scheme that is flexible enough to allocate multiple sets of antenna elements to different purposes, including transmitting and receiving signals between cooperating devices associated with (1) wireless data communication, (2) wireless power transmission, and (3) wireless power control.

These and other features, and advantages, of the disclosed systems and methods are described in, or apparent from, the following detailed description of various exemplary embodiments.

### BRIEF DESCRIPTION OF THE DRAWINGS

Various exemplary embodiments of the disclosed systems and methods for implementing wireless power transmission using 60 GHz mmWave wireless communication will be described, in detail, with reference to the following drawings, in which:

FIG. 1 illustrates an exemplary overview of an existing wireless power transmission system;

FIG. 2 illustrates an exemplary overview of a currently-planned first generation 60 GHz mmWave wireless communication system including exemplary beamforming according to proposed first generation 60 GHz mmWave wireless communication standards;

FIG. 3 illustrates an overview of an exemplary concept for implementation of a wireless power transmission scheme interlaced with wireless data communications in a 60 GHz mmWave wireless communication system according to this disclosure;

FIG. 4 illustrates a block diagram of an exemplary wireless communication system for implementing 60 GHz mmWave wireless power transmission according to this disclosure;

FIG. 5 illustrates a block diagram of an exemplary 60 GHz mmWave wireless communication device according to this disclosure; and

FIG. 6 illustrates a flowchart of an exemplary method for implementing wireless power transmission using 60 GHz mmWave wireless communication according to this disclosure.

### DETAILED DESCRIPTION OF THE DISCLOSED EMBODIMENTS

The systems and methods for implementing wireless power transmission using 60 GHz mmWave wireless communication according to this disclosure will generally refer to this specific utility, and this specific region of the RF spectrum, for those systems and methods. Exemplary embodiments described and depicted in this disclosure should not be interpreted as being specifically limited to any particular combination of communicating capabilities in a single transmitting or receiving device, or to any specific system infrastructure, or as limiting any particular intended use for the described system infrastructure, or specific transmitting/receiving devices. In fact, any wireless power transmission scheme that may make advantageous use of directional beamforming for wireless communication between cooperating devices to focus the transmitted/received power between those devices, and any complementary configuration for a power transmission device or a power reception device that may advantageously employ the wireless power transmission concepts according to this disclosure is contemplated.

Specific reference to, for example, any particular wireless data communication, or wireless power transmission or reception, device should be understood as being exemplary only, and not limited, in any manner, to any particular class of wireless communicating devices. The systems and methods according to this disclosure may be considered as being particularly adaptable to wireless power transmission to one or more hand-held wireless transmitting, receiving devices that include at least one 60 GHz mmWave radio. Such hand-held wireless transmitting/receiving devices are anticipated to include, for example, smartphones, tablets, PDAs and other like devices that mature from current classes of these devices with the inclusion of at least one 60 GHz mmWave radio in the devices, and the network or other nodes with which these devices may communicate. Reference to such devices is made for illustration purposes, i.e. for clarity and ease of understanding in providing a commonly understood frame of reference for describing the disclosed concepts. These disclosed concepts should not, however, be considered as being limited to only these classes of client devices or their successors in kind. In fact, the wireless power reception devices, as generally described in this disclosure, need not be mobile, or otherwise hand-held, at all. It is envisioned, for example, that directed wireless power transmission, as described in this disclosure, may be advantageously employed to recharge power storage units that may, for example, be permanently installed in fixed locations, or otherwise installed in different categories of vehicles.

Individual features and advantages of the disclosed systems and methods will be set forth in the description that follows, and will be, in part, obvious from the description, or may be learned by practice of the features described in this disclosure. The features and advantages of the systems and methods according to this disclosure may be realized and obtained by means of the individually disclosed elements, and combinations of those elements to form wireless communicating systems, or to carry out the wireless communicating methods, as particularly pointed out in the appended claims. While specific implementations are discussed, it should be understood that this is done for illustration purposes only. A person skilled in the relevant art will recognize that other components and configurations may be used without departing from the spirit and scope of the subject matter of this disclosure.

Various aspects of the disclosed embodiments relate to (1) systems for implementing directional wireless power transmission using one or more beamformed wireless communication links between a power source and a power sink such as a powered load or a power storage device, particularly systems operating in a mmWave region of the RF spectrum at, for example, 60 GHz, (2) methods for carrying into effect the described implementation of wireless power transmission in such systems, and (3) a corresponding non-transitory computer-readable medium having recorded on it a program that, when executed by a processor, causes the processor to execute the steps of one or more of the methods for implementing wireless power transmission using 60 GHz mmWave wireless communication according to this disclosure.

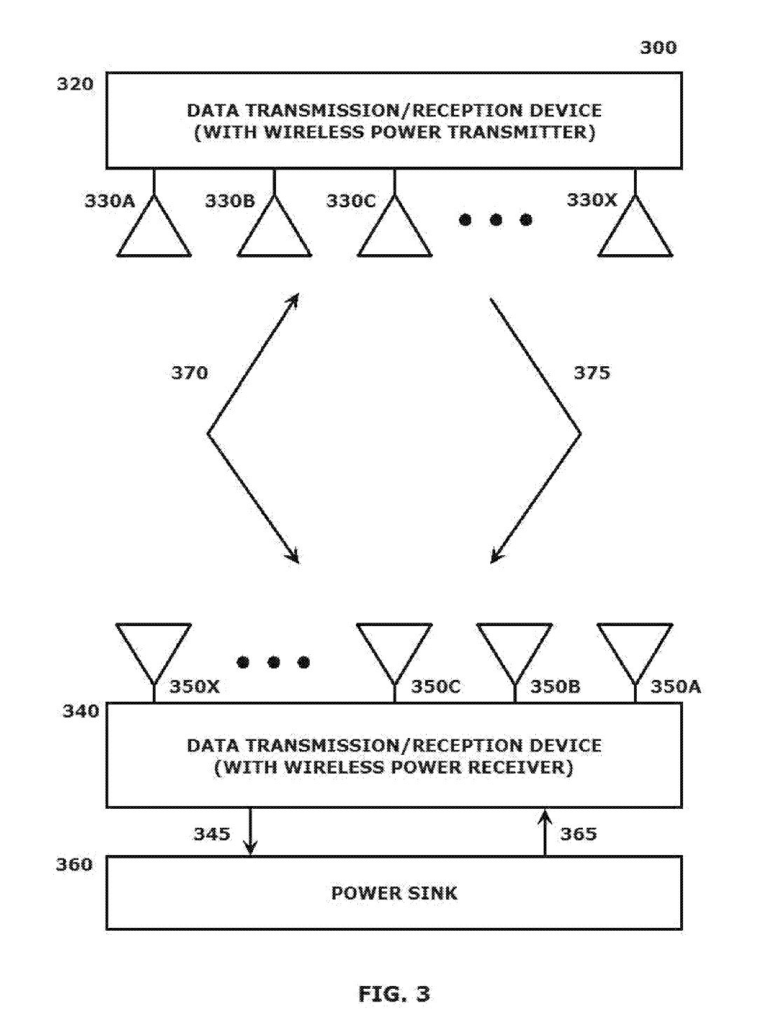

FIG. 3 illustrates an overview of an exemplary concept 300 for implementation of a wireless power transmission scheme interlaced with wireless data communications in a 60 GHz mmWave wireless communication system according to this disclosure. Generally, the concept depicted in FIG. 3 references the proposed IEEE 802.11 ad/WiGig standard that provides that 60 GHz mmWave wireless communication devices, e.g. a first data transmission/reception device 320 and a second data transmission/reception device 340, will generally be equipped with large numbers of antenna elements 330A-X, 350A-X, respectively, i.e., up to 64 antenna elements in each of what may be multiple antennas. Given this construct, it may be possible to allocate multiple subsets of antenna elements 330A-X, 350A-X to different beamformed wireless communication links 370, 375 that may communicate separate signals between the cooperating first data transmission/reception device 320 and second data transmission/reception device 340 that can be used for different purposes.

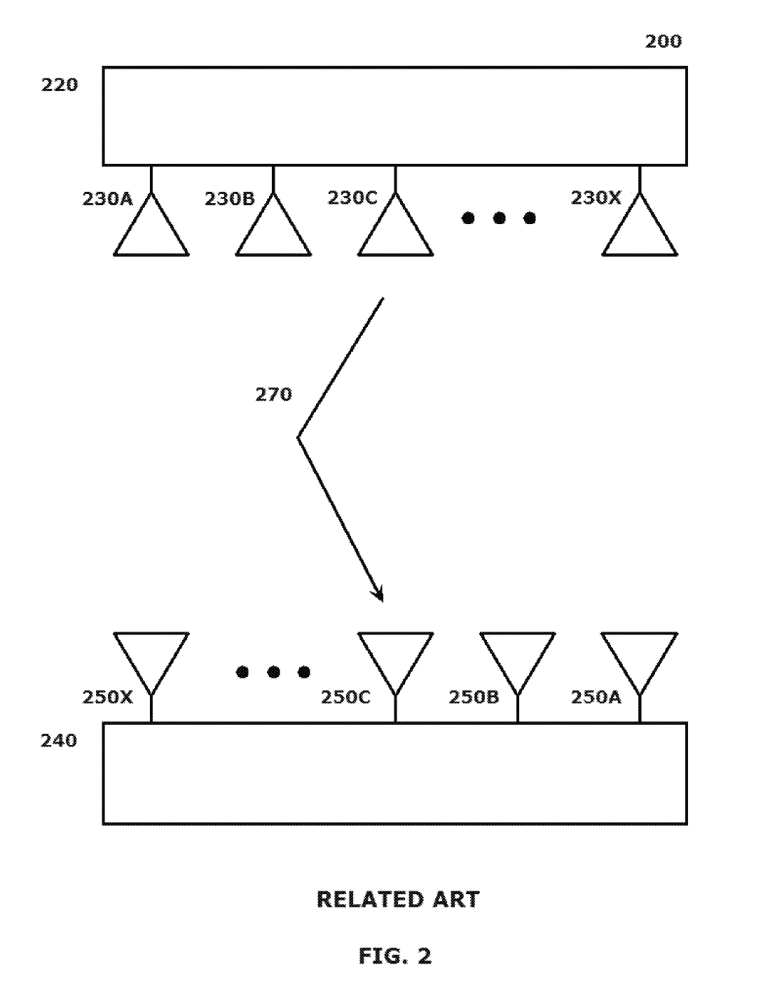

As an example, the first data transmission/reception device 320 may include a wireless power transmitter and N, where N is greater than 2, antenna elements 330A-X. The second data transmission/reception device 340 may include a wireless power receiver and M, where M is greater than 2, antenna elements 350A-X. The cooperating first data transmission/reception device 320 and second data transmission/reception device 340 may each respectively allocate n antenna elements 330A-X, where n is less than or equal to N, and m antenna elements 350A-X, where m is less than or equal to M, for wireless power transmission across one or more beamformed wireless communication links 375. The remaining antenna elements 330A-X, 350A-X may then be allocated in each of the respective cooperating first data transmission/reception device 320 and second data transmission/reception device 340 for two-way data communication between the cooperating first data transmission/reception device 320 and second data transmission/reception device 340 across one or more other beamformed wireless communication links 370 in order to transmit and receive (1) data communication signals (see FIG. 2 for network signals for the depiction of the current implementation of the proposed IEEE 802.11ad/WiGig standard), and (2) appropriate control signals for control of the wireless power transmission scheme carried out between the cooperating devices.

In the above manner, a same set of cooperating first and second data transmission/reception devices 320,340 forming cooperating ends of a 60 GHz mmWave communication system, with multiple separate beamformed wireless communication links 370,375 formed therebetween according to an antenna allocation scheme, with no additional radios using 60 GHz mmWave technology, can be used to fulfill multiple purposes. Source and destination devices may allocate all antenna elements for wireless power transmission in circumstances where, for example, wireless power transmission is needed or otherwise there is no data traffic communication between the devices. Source and destination devices may allocate all antenna elements for data traffic communication, in cases where, for example, wireless power transmission is not needed or data traffic communication is deemed to have priority. Separately, and more commonly, source and destination devices may dynamically allocate numbers of antenna elements depending upon, for example, a balancing of wireless power transmission and data traffic communication needs. Dynamic antenna element allocation may, for example, result in a comparatively larger number of antenna elements being allocated to wireless power transmission in circumstances where a power sink such as a battery in communication with a destination (power reception) device needs to be recharged. Priority for antenna element allocation may, however, shift to data traffic communication, for example, once either of the cooperating communicating devices a device starts a video application, i.e., the power source and power destination devices may dynamically shift the allocation of antenna elements to transmission/reception of the video data signal in an attempt to ensure reliable data traffic communication.

For simplicity and ease of understanding, FIG. 3 is limited to depiction of a 60 GHz mmWave wireless communication system including only a single second data transmission/reception device 340, which may be considered for the purposes of this disclosure an exemplary single receiver. It should be understood, however, that the depicted concept is intended to encompass wireless power transmission that may flow in either direction and with multiple cooperating power receiving devices.

The above-described configuration advantageously employs the additional degrees of freedom and directionality that are provided with regard to how the antennas and the antenna elements are used, for example, in a beamforming scheme, in a 60 GHz mmWave wireless communication system. Individual signals for separate purposes may be transmitted and received across links that can be beamformed using differing numbers of individual antenna elements at each of the ends of the wireless communication link. The numbers of antenna elements used by the first data transmission/reception device 320 and the second data transmission/reception device 340 to form each of the beamformed wireless communication links 370,375 can vary. The numbers of antenna elements used by either of the first data transmission/reception device 320 or the second data transmission/reception device 340 may range from using one, or a small number of, antenna element(s) to using all of the antenna elements of a particular antenna. Through each beamformed wireless communication link 370,375 different signals may be transmitted to different purposes as described above.

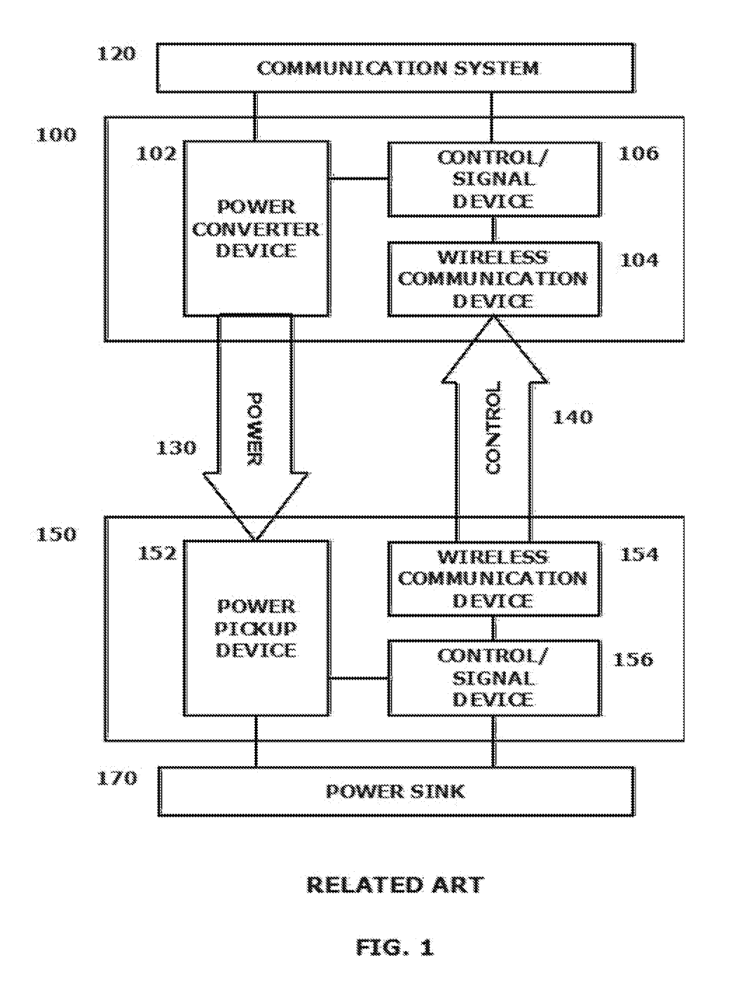

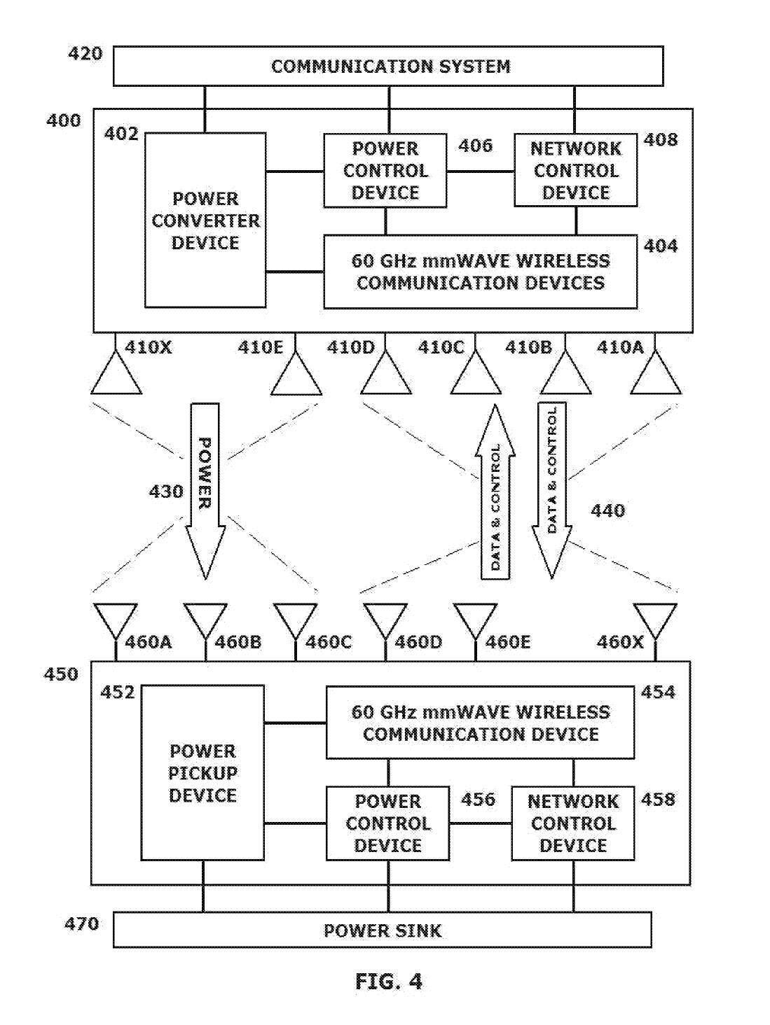

FIG. 4 illustrates a block diagram of an exemplary wireless communication system for implementing 60 GHz mmWave wireless power transmission according to this disclosure. As shown in FIG. 4, a first data transmission/reception device 400 including a power converter device 402 communicates with a cooperating second data transmission/reception device 450 including of our pickup device 452. As in the configuration shown in FIG. 1, a first data transmission/reception device 400 and the cooperating second data transmission/reception device 450 may be positioned between a communication system 420 and a power sink 470. The power sink 470 may be a power load device to be powered by the power received by a power pickup device 452 in the cooperating second data transmission/reception device 450, or a power storage device, such as a battery, that is recharged by the power received by the power pickup device 452.

The first data transmission/reception device 400 may include a power converter device 402, one or more 60 GHz mmWave wireless communication devices 404, a power control device 406 and a network control device 408. In like manner, the second data transmission/reception device 450 may include the power pickup device 452, one or more 60 GHz mmWave wireless communication devices 454, a power control device 456 and a network control device 458. The one or more 60 GHz mmWave wireless communication devices 404,454 may each execute an antenna element allocation scheme in support of a beamforming scheme that allocates a number of individual antenna elements 410A-X, 460A-X, respectively, to each of multiple directional beamformed wireless communication links between the first data transmission/reception device 400 and the cooperating second data transmission/reception device 450.

The respective antenna allocation schemes and beamforming schemes undertaken by the one or more 60 GHz mmWave wireless communication devices 404,454 respective first and second data transmission/reception devices 400,450 may form a specific number of the multiple directional beamformed wireless communication links between the cooperating devices, or may dynamically change a number of the multiple directional beamformed wireless communication links between the cooperating devices as transmission requirements between the cooperating devices dynamically change.

The power sink 470 may communicate with the second data transmission/reception device 450 to indicate a power requirement to the second data transmission/reception device 450 via power control device 456. Power control device 456 via one or more of the multiple directional beamformed wireless communication links established according to the antenna allocation scheme and beamforming scheme between the one or more 60 GHz mmWave communication devices 454,404 may communicate a power requirement to power control device 406 as a data control signal across a data and control signal path 440. Power control device 406 may cause the power converter device 402 to generate a power signal to be transmitted via a power signal path 430 to the power pickup device 452 in the second data transmission/reception device 450. The power pickup device 452 may, in turn, communicate received energy from the power signal 430 as a power input to the power sink 470, e.g. to power a local device or to charge a battery.

Separately, the network control device 408,458 in either of the first or second data transmission/reception devices 400,450 may place in priority data communications between the cooperating devices over wireless power transmission. In such a case, according to some predetermined scheme, one or the other of the network control devices 408,458 may transmit, in either direction, a control signal to suspend wireless power transmission during the duration of a data communication transmission across the data and control signal path 440. As shown in FIG. 4, each of the power signal path 430 and the data and control signal path 440 are not necessarily associated with any one or more of separate multiple beamformed wireless communication links between the cooperating devices. Rather, it should be understood that, given the dynamic nature of an allocation scheme supporting a dynamic multiple beamforming scheme, the one or more of the separate multiple beamforming wireless communication links that may be selected at any given point to support either of the power signal path 430 or the data and control signal path 440 may be constantly changing. As an example, a power control signal to be transmitted via the data and control signal path 440 may be generated by the power control device 456 when it may be necessary to indicate that more energy is required by the power sink 470. Separately, if a determination is made by the power control device 456 that no more energy is required by the power sink 470, or separately determinations made by either of network control devices 408,458 that data communication transmission needs to be made between the cooperating devices, a control signal sent via the data and control signal path 440 may indicate to the power control device 406 to direct the power converter device 402 to stop or otherwise limit transmitting the power signal 430 to the power pickup device 452. With this suspension or limitation, one or both of the network control devices 408,458 may commence transmission of data communications in either direction via the data and control signal path 440 across all or some of the now-available multiple beamformed wireless communication links between the devices.

It must be understood that the proposed system for cooperatively integrating wireless power transmission in a 60 GHz mmWave wireless communicating system has an advantage of being able to employ multiple beamformed wireless communication links between cooperating wireless communication devices to execute (1) all wireless power transmission, (2) all data communication transmission, or (3) constantly changing weighted combinations of both.

Also as should be generally understood by the above discussion, FIG. 4 generally depicts a high-level system overview for using 60 GHz mmWave communication to provide wireless power transmission interlaced, as appropriate, with wireless data communication transmission on separate beamformed wireless communication links. Generally, what could reasonably be considered power source and destination devices may be equipped, as shown, with one or more 60 GHz mmWave wireless communication devices 404,454 that may vary according to a specific implementation of the depicted exemplary system. Individual 60 GHz mmWave wireless communication devices 404,454 may be dedicated for wireless power and/or wireless data communication transmission. Individual 60 GHz mmWave wireless communication devices 404, 454 may individually or cooperatively dynamically select a purpose of each device. In instances where a single 60 GHz mmWave wireless communication device 404,454 is used for both wireless power transmission and data communication transmission (or networking), more than one beamformed wireless communication link between the source and destination devices is required so that the different signals can be transmitted, as shown in FIG. 3.

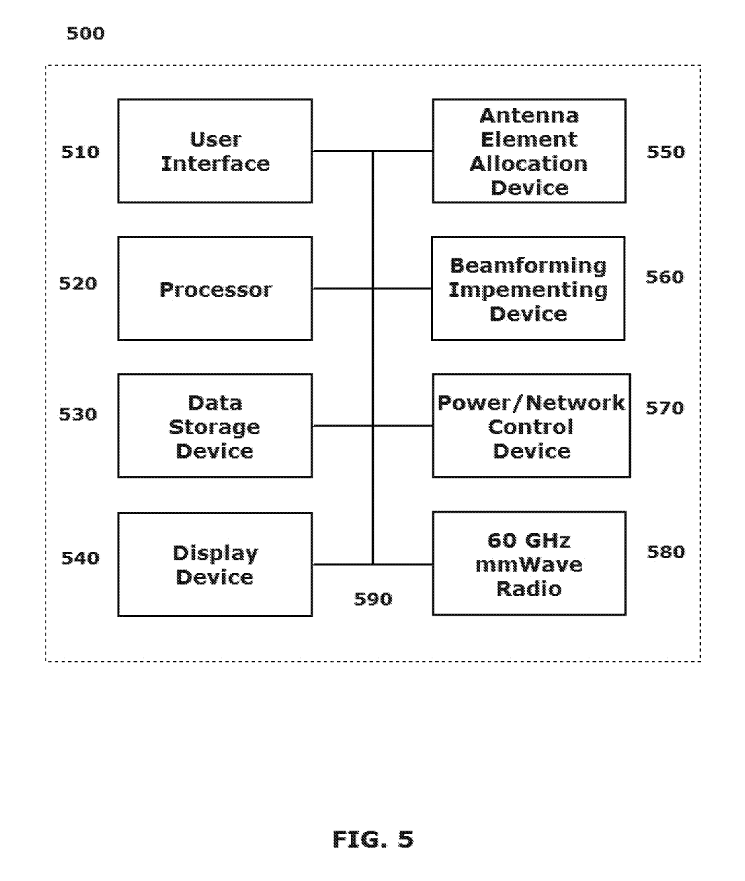

FIG. 5 illustrates a block diagram of an exemplary wireless communication device 500 that may constitute either of the constitute any of the one or more 60 GHz mmWave communication devices 454,404, for example, in either of the first or second data transmission/reception devices 400,450 shown in FIG. 4. The wireless communication device 500 may be a part of any one of a fixed or mobile wireless transmission/reception node. If fixed, the wireless communication device 500 may constitute a part of a wireless network node or a remote fixed wireless device in communication with a peer device or a wireless network node. If mobile, wireless communication device 500 may constitute a part of a hand-held wireless communication device such as, for example, a smartphone, tablet, PDA or other like mobile device, or may be a wireless communication device mounted in a mobile vehicle.

The wireless communication device 500 may include a user interface 510 by which a user can communicate with the wireless communication device 500, and may otherwise communicate information via the wireless communication device 500 to a cooperating wireless communication device with which the wireless communication device 500 is in wireless communication. The user interface 510 may be configured as one or more conventional mechanisms that permit a user to input information to the wireless communication device 500.

The wireless communication device 500 may include one or more local processors 520 for individually undertaking the processing and control functions that are carried out by the wireless communication device 500. Processor(s) 520 may include at least one conventional processor or microprocessor that interprets and executes instructions and processes outgoing and incoming data and control signals transmitted to or received from the wireless communication device 500 via one or more multiple beamformed wireless communication links.

The wireless communication device 500 may include one or more data storage devices 530. Such data storage device(s) 630 may be used to store data, and operating programs or applications to be used by the wireless communication device 500, and specifically the processor(s) 520, particularly programs and applications that support a beamforming scheme to establish multiple separate beamformed wireless communication links with a cooperating wireless communication device and that in turn support implementing a power transmission scheme among the multiple separate beamformed communication links once established. Such data storage device(s) 530 may further store algorithms and parameters to carry into effect an antenna allocation scheme in support of forming and managing the multiple separate beamformed communication links for cooperatively providing wireless power transmission and data communication and control transmission between the wireless communication device 500 and another wireless communication device with which the wireless communication device 500 communicates. Data storage device(s) 530 may include a random access memory (RAM) or another type of dynamic storage device that stores beamforming information, wireless power transmission control and implementation information or other information and instructions for execution by the processor(s) 520. Data storage device(s) 530 may also include a read-only memory (ROM), which may include a conventional ROM device or another type of static storage device that stores static information and instructions for execution by the processor(s) 520.

The wireless communication device 500 may include at least one data display device 540 which may be configured as one or more conventional mechanisms that display information to the user of the wireless communication device 500 for operation of the wireless communication device 500 in its various operations, or otherwise for displaying, for example, data received from a cooperating wireless communication device via the combination of separate beamformed communication links communicating separate signals between the devices.

The wireless communication device 500 may include one or more antenna allocation devices 550. Such an antenna element allocation device 550 may autonomously, or in cooperation with the processor(s) 520 and/or data storage devices 530, be used by the wireless communication device 500 to dynamically execute an antenna allocation scheme in support of establishing and maintaining multiple beamformed wireless communication links between the wireless communication device 500 and a cooperating wireless communication device.

The wireless communication device 500 may include a separate beamforming implementing device 560. Such a beamforming implementing device 560, like the antenna/element allocation device 550, may autonomously, or in cooperation with the processor(s) 520 and/or data storage devices 530, be used by the wireless communication device 500 to implement the processes to establish and maintain a plurality of beamformed wireless communication links between the wireless communication device 500 and one or more cooperating wireless communication devices with which the wireless communication device 500 is in wireless communication to support potentially dynamically changing wireless power transmission and data communication and control signal transmission between cooperating devices.

The wireless communication device 500 may include integrally, or as a separate device or devices, one or more power/network control devices 570 that may carry out the functions as described above for these devices, depicted as separate devices and FIG. 4.

The wireless communication device 500 may include at least one 60 GHz mmWave radio 580, which represents an external data communication interface for specific communication with a cooperating wireless communication device across the multiple beamformed wireless communication links between the devices.

All of the various components of the wireless communication device 500, as depicted in FIG. 5, may be connected by one or more data/control busses 590. The data/control bus(ses) 590 may provide internal wired or wireless communication between the various components of the wireless communication device 500, when all of those components are housed integrally in the wireless communication device 500. Otherwise, the various disclosed elements of the wireless communication device 500 may be arranged in combinations of sub-systems as individual components or combinations of components, housed in a single location or remotely dispersed in multiple locations and in wired or wireless communication with other of the individual components of the wireless communication device 500. In other words, no specific configuration as an integral unit or as a support unit, or as several units or sub-systems widely dispersed, for the wireless communication device 500 is to be implied by the depiction in FIG. 5.

The disclosed embodiments may include a method for implementing wireless power transmission using 60 GHz mmWave wireless communication. According to the exemplary method, one potentially cooperating 60 GHz mmWave wireless communication device may attempt to initiate communication with one or more other potentially cooperating 60 GHz mmWave wireless communication devices. The method may establish multiple beamformed wireless communication links between the pair of cooperating 60 GHz mmWave wireless communication devices. Once multiple beamformed wireless communication links are established between the pair of cooperating 6o GHz mmWave wireless communication devices, the method may determine whether wireless power transmission should be implemented between one of the cooperating 60 GHz mmWave wireless communication devices and an other of the cooperating 60 GHz mmWave wireless communication devices. If the method determines that wireless power transmission should be implemented between the cooperating devices, an antenna allocation scheme may be implemented such that power generated by a power source in one of the cooperating devices is delivered via one or more of the multiple beamformed wireless communication links to a power pickup device in the other of the cooperating devices. It should be noted that this determination step could alternatively determine whether wireless data communication transmissions should be implemented between the one of the cooperating 60 GHz mmWave wireless communication devices and the other of the cooperating 60 GHz mmWave wireless communication devices to implement antenna allocation scheme such that data available in one of the cooperating devices is delivered via one or more of the multiple beamformed wireless communication links to a receiver in the other of the cooperating devices. The method may continue to balance wireless power transmission and wireless data communication transmission requirements among multiple beamformed wireless communication links between the cooperating devices until the power transmission and data exchange between those devices is complete.

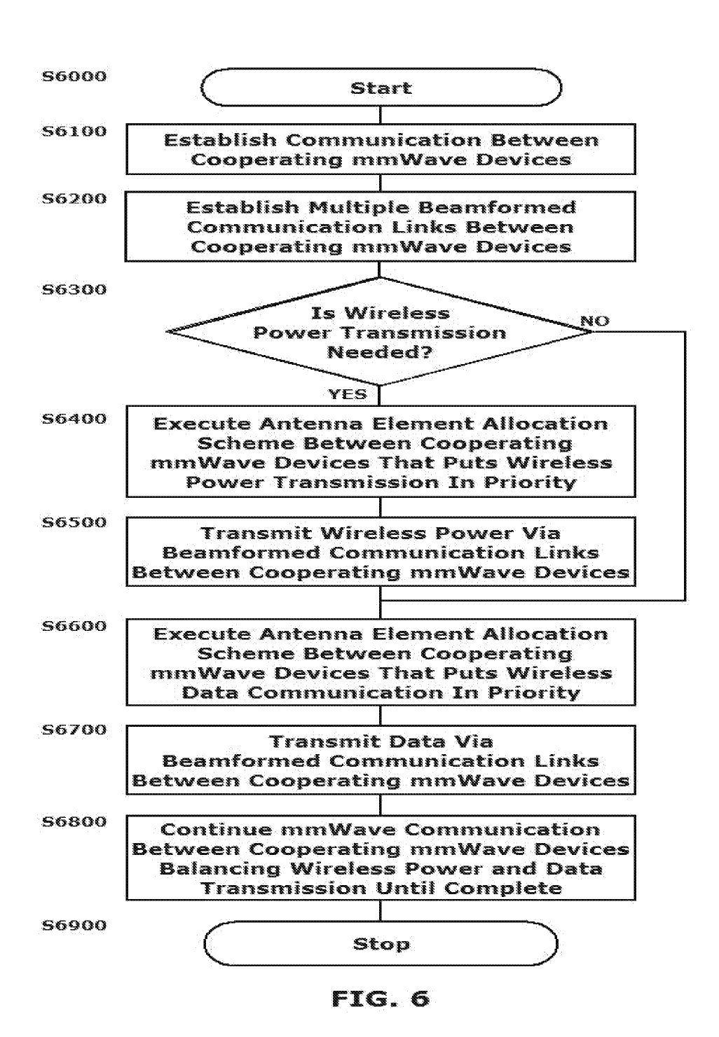

FIG. 6 illustrates a flowchart of an exemplary method for implementing wireless power transmission using 60 GHz mmWave wireless communication according to this disclosure. As shown in FIG. 6, operation of the method commences at Step S6000 and proceeds to Step S6100.

In Step S6100, one potentially cooperating 60 GHz mmWave wireless communication device may attempt to establish communication with an other potentially cooperating mmWave wireless communication device. The one potentially cooperating 60 GHz mmWave wireless communication device may attempt to establish this communication by, for example, initiating a request to communicate with the other potentially cooperating 60 GHz mmWave wireless communication device using any available means communication link supported by one or more radios in each of the potentially cooperating 60 GHz mmWave wireless communication devices. Operation of the method proceeds to Step S6200.

In Step S6200, the pair of potentially cooperating 60 GHz mmWave wireless communication devices may execute a beamforming scheme to establish separate multiple beamformed wireless communication links between the devices. It is anticipated that the beamforming scheme for each of the separate multiple beamformed wireless communication links will be undertaken by known methods. Operation of the method proceeds to Step S6300.

Step S6300 is a determination step. In Step S6300, a determination is made whether wireless power transmission between the cooperating 60 GHz mmWave wireless communication devices is needed. As indicated above, it should be noted that this determination step could alternatively determine whether wireless data communication transmissions should be implemented between the cooperating 60 GHz mmWave wireless communication devices.

If, in Step S6300, it is determined that wireless power transmission between the cooperating 60 GHz mmWave wireless communication devices is not needed, operation of the method may proceed to Step S6600 where wireless data communication transmissions are placed in priority.

If, in Step S6300, it is determined that wireless power transmission between the cooperating 60 GHz mmWave wireless communication devices is needed, operation of the method proceeds to Step S6400.

In Step S6400, an antenna allocation scheme may be undertaken by either, or both, of the cooperating 60 GHz mmWave wireless communication devices. This antenna allocation scheme may be directed at optimally employing available antenna elements to support the multiple beamformed wireless communication links for directed wireless power transmission from one of the cooperating devices to the other. Operation of the method proceeds to Step S6500.

In Step S6500, wireless power is transmitted via one or more of the multiple beamformed wireless communication links from a power source device to a power destination device among the cooperating 60 GHz mmWave wireless communication devices. Operation of the method proceeds to Step S6600.

In Step S6600, a separate antenna allocation scheme may be undertaken by either, or both, of the cooperating 60 GHz mmWave wireless communication devices. This antenna allocation scheme may be directed at optimally employing available antenna elements to support the multiple beamformed wireless communication links for wireless data communication transmission from one of the cooperating devices to the other. Operation of the method proceeds to Step S6700.

In Step S6700, wireless data communication is transmitted via one or more of the multiple beamformed wireless communication links from a one of the cooperating devices to the other. This data may include data content and one or more of network and power control signals as discussed above. Operation of the method proceeds to Step S6800.

In Step S6800, wireless power transmission and wireless data communication (and control) transmission may proceed optimally and dynamically across an established set of multiple beamformed wireless communication links between cooperating 60 GHz mmWave wireless communication devices until there is no longer a need for either of the wireless power transmissions and wireless data communication (and control) transmissions across the 60 GHz mmWave wireless communication links between the cooperating devices, at which point operation of the method proceeds to Step S6900 where operation of the method ceases.

The disclosed embodiments may include a non-transitory computer-readable medium storing instructions which, when executed by a processor, may cause the processor to execute the steps of a method as outlined above.

The above-described exemplary systems and methods reference certain known, or in development, components to provide a brief, general description of a suitable communication and processing environment in which the subject matter of this disclosure may be implemented for familiarity and ease of understanding. Although not required, embodiments of the disclosure may be provided, at least in part, in a form of hardware circuits, firmware or software computer-executable instructions to carry out the specific functions described, such as program modules, being executed by a processor to execute beamforming and to intelligently prioritize between wireless power transmission requirements and wireless data communication requirements among multiple beamformed wireless communication links between cooperating 60 GHz mmWave wireless communication devices. Generally, these program modules may include routine programs, objects, components, data structures, and the like that perform the particular tasks described, or implement particular data types.

Those skilled in the art will appreciate that other embodiments of the disclosed subject matter may be envisioned for execution across directed 60 GHz mmWave communication links between cooperating devices with many types communication equipment and computing system configurations, particularly in, for example, a hand-held or otherwise portable devices including at least one 60 GHz mmWave radio for wireless communication.

Embodiments may also be practiced in distributed network communication environments where tasks, generally as outlined above, may be performed by local and remote processing devices that are linked to each other by hardwired links, wireless links, or a combination of both through a communication network that includes at least cooperating 60 GHz mmWave communication devices in fixed or mobile configurations that make up ends of separate multiple beamformed wireless communication links between the devices.

Embodiments within the scope of the present disclosure may also include computer-readable media having stored computer-executable instructions or data structures that can be accessed, read and executed by the described 60 GHz mmWave wireless communication devices. Such computer-readable media can be any available media that can be accessed by a processor in, or in communication with, the a 60 GHz mmWave wireless communication device. By way of example, and not limitation, such computer-readable media can comprise RAM, ROM, EEPROM, CD-ROM, DVD-ROM, flash drives, thumb drives, data memory cards or other analog or digital data storage devices that can be used to carry or store desired program elements or steps in the form of accessible computer-executable instructions or data structures. When information is transferred or provided over a network or another communications connection, the receiving processor may properly view the connection as a computer-readable medium. Thus, any such connection is properly termed a computer-readable medium. Combinations of the above should also be included within the scope of the computer-readable media for the purposes of this disclosure.

Computer-executable instructions include, for example, non-transitory instructions and data that can be executed and accessed respectively to cause individual wireless communication devices, or processors in such devices, to perform certain of the above-specified functions, individually, or in combination. Computer-executable instructions also include program modules that are remotely stored for access by the wireless communication devices to be executed by processors in the wireless communication devices when those devices are caused to communicate in wireless communication environments across any communication link such as the multiple beamformed wireless communication links depicted and described in exemplary manner above.

The exemplary depicted sequence of executable instructions, or associated data structures for executing those instructions, represents one example of a corresponding sequence of acts for implementing the functions described in the steps. As is explicitly stated above, either of wireless power transmission or wireless data communication transmission may be placed in priority over the other, or proper balancing of wireless power transmission and wireless data communication transmission may occur in parallel according to executed antenna allocation and beamforming schemes. The steps of the method, as depicted, are not intended to imply any particular order to the depicted steps except as may be necessarily inferred when one of the depicted steps is a necessary precedential condition to accomplishing another of the depicted steps.

Although the above description may contain specific details, they should not be construed as limiting the claims in any way. Other configurations of the described embodiments of the disclosed systems and methods are part of the scope of this disclosure. For example, the principles of the disclosure may be applied to each individual of one or more of a mobile 60 GHz mmWave wireless communication device operating in a particular network communicating environment in communication, for example, with a single central 60 GHz mmWave wireless communication device. This enables each user to use the benefits of the disclosure even if any one of a large number of possible applications do not need a specific aspect of the functionality described and depicted in this disclosure. In other words, there may be multiple instances of the components each processing the content in various possible ways. It does not necessarily need to be one system used by all end users. Accordingly, the appended claims and their legal equivalents should only define the disclosure, rather than any specific examples given.

We claim:

1. A method for executing wireless power transmission, comprising:
establishing, by a processor, multiple separate beamformed wireless communication links between cooperating 60 GHz mmWave wireless communicating devices;
generating a power signal by a power source in one of the cooperating 60 GHz mmWave wireless communicating devices; and
transmitting the generated power signal to a power sink in communication with the other of the cooperating 60 GHz mmWave wireless communicating devices across one or more of the multiple separate beamformed wireless communication links between the cooperating 60 GHz mmWave wireless communicating devices.

2. The method of claim 1, further comprising transmitting at least one of wireless data communications other than the generated power signal and control signals for the power signal generating across a separate one or more of the multiple separate beamformed wireless communication links between the cooperating 60 GHz mmWave wireless communicating devices.

3. The method of claim 2, the processor determining at least one of which of the multiple separate beamformed wireless communication links is used to transmit the generated power signal between the cooperating 60 GHz mmWave wireless communicating devices and which of the multiple separate beamformed wireless communication links is used to transmit the at least one of the wireless data communications other than the generated power signal and the control signals for the power signal generating between the cooperating 60 GHz mmWave wireless communicating devices.

4. The method of claim 1, further comprising executing an antenna element allocation scheme that assigns a number of antenna arrays or antenna elements available in at least one of the cooperating 60 GHz mmWave wireless communicating devices to each of the multiple separate beamformed links between the cooperating 60 GHz mmWave wireless communicating devices to transmit the generated power signal.

5. The method of claim 4, the antenna element allocation scheme dynamically modifying the number of antenna arrays or antenna elements assigned to transmitting the generated power signal based on at least one received control signal.

6. The method of claim 5, the at least one received control signal indicating that no further wireless power should be transmitted to the power sink.

7. The method of claim 6, the at least one received control signal causing the power source to cease generating the power signal.

8. The method of claim 5, the at least one received control signal indicating that one of the cooperating 60 GHz mmWave wireless communicating devices is transmitting data communications to the other of the cooperating 60 GHz mmWave wireless communicating devices.

9. The method of claim 5, the antenna allocation scheme assigning all of the antenna elements to transmitting the generated power signal.

10. The method of claim 5, the antenna allocation scheme assigning all of the antenna arrays or antenna elements to transmitting wireless data communications other than the generated power signal and the control signals for the power signal generating.

11. A system for executing wireless power transmission, comprising:
a first wireless communicating device, comprising:
a power generating device for generating a power signal;
a first control device that controls the power generating device and wireless communications transmitted from and received by the first wireless communicating device; and
a first 60 GHz mmWave transmitter/receiver in communication with the first control device, and including an antenna array with multiple antenna elements;
a second wireless communicating device, comprising:
a power receiving device for wirelessly receiving the power signal generated by the power generating device and generating power based on the received power signal;
a second control device that controls the power receiving device and wireless communications transmitted from and received by the second wireless communicating device; and
a second 60 GHz mmWave transmitter/receiver in communication with the second control device, in wireless communication with the first 60 GHz mmWave transmitter/receiver and including an antenna array with multiple antenna elements; and
a power sink for receiving the generated power from the power receiving device,
at least one of the first and second 60 GHz mmWave transmitter/receivers establishing multiple beamformed wireless communication links with the other of the first and second 60 GHz mmWave transmitter/receivers for transmitting separate signals between the first and second 60 GHz mmWave transmitter/receivers.

12. The system of claim 11, the separate signals including at least one the power signal, data communications other than the power signal and control signals for controlling the power signal.

13. The system of claim 11, at least one of the first and second wireless communication devices being configured to execute an antenna allocation scheme for assigning a number of respective antenna arrays or antenna elements in each of the first and second 60 GHz mmWave transmitter/receivers to each of the established multiple beamformed wireless communication links for transmitting the power signal.

14. The system of claim 13, the at least one of the first and second wireless communication devices executing the antenna allocation scheme to assign all of the respective antenna arrays or antenna elements in each of the first and second 60 GHz mmWave transmitter/receivers to the established beamformed wireless communication links for transmitting the power signal.

15. The system of claim 13, the at least one of the first and second wireless communication devices executing the antenna allocation scheme to assign a first number of the respective antenna arrays or antenna elements in each of the first and second 60 GHz mmWave transmitter/receivers to a first group of the established beamformed wireless communication links for transmitting the power signal and to assign a second number of the respective antenna arrays or antenna elements in each of the first and second 60 GHz mmWave transmitter/receivers to a second group of the established beamformed wireless communication links for transmitting data communications other than the power signal and control signals for controlling the power signal.

16. The system of claim 11, the power sink comprising at least one of a load that is powered by the generated power from the power receiving device and a power storage device that is recharged by the generated power from the power receiving device.

17. The system of claim 16, the power sink communicating to the second control device that power is required by the power sink, the second control device generating a control signal to the first control device to generate the power signal.

18. The system of claim 16, the power sink communicating to the second control device that no power is required by the power sink, the second control device generating a control signal to the first control device to stop generating the power signal.

19. The system of claim 11, the first wireless communicating device including only a single first 60 GHz mmWave transmitter/receiver, and the second wireless communicating device including only a single second 60 GHz mmWave transmitter/receiver in wireless communication with the single first 60 GHz mmWave transmitter/receiver, and
the establishing multiple beamformed wireless communication links separately carry all of the separate signals including the power signal, data communications other than the power signal and control signals for controlling the power signal between the single first and the single second 60 GHz mmWave transmitter/receivers.

20. A non-transitory computer-readable medium storing computer-readable instructions which, when executed by a processor, cause the processor to execute a wireless power transmission, comprising:
establishing multiple separate beamformed wireless communication links between cooperating 60 GHz mmWave wireless communicating devices;
generating a power signal by a power source in one of the cooperating 60 GHz mmWave wireless communicating devices; and
transmitting the generated power signal to a power sink in communication with the other of the cooperating 60 GHz mmWave wireless communicating devices across one or more of the multiple separate beamformed wireless communication links between the cooperating 60 GHz mmWave wireless communicating devices.
